(19) United States
(12) Patent Application Publication
(10) Pub. No.: US 2010/0238064 A1
(43) Pub. Date: Sep. 23, 2010

(54) LOCATION BASED ALERT DEVICE WITH IMPROVED DISPLAY

(76) Inventors: Vincent C. FORMANEK, Hillside, IL (US); Hiroshi Kainuma, Arlington Heights, IL (US); Ricky J. Mucia, Chicago, IL (US); Jeffrey A. Sterling, Lombard, IL (US); Philip E. Thistlethwaite, Arlington Heights, IL (US)

Correspondence Address: HITCHCOCK EVERT LLP, P.O. BOX 131709, DALLAS, TX, 75313-1709, US

(21) Appl. No.: 12/405,343

(22) Filed: Mar. 17, 2009

(51) Int. Cl. H04K 3/00; G01S 7/36

(52) U.S. Cl. 342/20

(57) ABSTRACT

A GPS-enabled radar detector capable of storing a database of points of interest is provided. The radar detector comprises a display capable of indicating not only the presence of a point of interest, but also an indication of the direction between the unit and a specified point of interest. In an alternate embodiment, the device comprises a display capable of displaying multiple, simultaneous alerts.

### FIELD OF THE INVENTION

The present invention relates generally to an apparatus useful in road-going vehicles operated in areas which are known to include one or more automated traffic monitoring devices or other location based alert points. Such automated traffic monitoring devices may include fixed cameras positioned to record vehicles illegally passing through controlled intersections, generally known as “red-light cameras,” fixed vehicle speed monitoring devices, and combinations of such devices. Other location based alert points may include intersections or other road areas known to have a high incidence of traffic accidents, or may include user set points such as locations known to be frequently speed monitored. Taken together, these are known as points of interest.

The apparatus of the present invention is capable of monitoring the location of the vehicle in which it is used and comparing that location against the locations of known points of interest and performing various functions based on the vehicle's proximity to one or more points of interest. In a preferred embodiment, the apparatus of the present invention is equipped with a display which displays a directional vector illustrating the relationship between the vehicle and the point of interest. This directional display thus may enable the user of the vehicle to differentiate between alerts which are relevant to the user, given the user's direction of travel and the roadway on which they are traveling, and false alerts which may be triggered by nearby, but non-relevant points of interest.

### BACKGROUND

Modern roadways are monitored by a number of traffic control devices. Speed enforcement as well as enforcement of other traffic laws is handled by traditional law enforcement officers operating from motor vehicles who have been joined by a various unmanned traffic devices. Fixed and mobile speed detection devices (radar, laser, etc.) and fixed photographic devices designed to record incidents of motorists disobeying traffic regulations (“red light cameras”), are but two examples of modern tools used to enforce traffic regulations. Those skilled in the art will recognize that for many years there have been a number of tools used by drivers to provide an alert to these sorts of traffic control devices, with radar/laser detectors the most common. As used herein, the term radar detector will refer to any of a number of known speed detection units capable of detecting electromagnetic signals on the X-band, K-band or Ka-band. Furthermore, the radar detector will also be used to refer to speed detection units known as laser detectors, and could refer to any electromagnetic detector. Examples of known technology in this area include U.S. Pat. Nos. 5,784,021 and 5,151,701. However, radar detectors and their ilk rely on electromagnetic signals emitted from a traffic control device (such as a police radar gun) to recognize a traffic control device and thereafter alert the driver to its presence. Because many modern traffic control devices, such as red-light cameras, do not operate in the same areas of the electromagnetic spectrum as radar detectors, and because red-light cameras, for example, do not continuously emit electromagnetic radiation, radar detectors are ineffective at alerting drivers to the presence of this type of device.

To address this problem, and to alert drivers to the presence of traffic control devices, devices utilizing the Global Positioning System (“GPS”) have been employed. In some examples of the prior art, a database of known locations of traffic control devices is stored by a GPS-enabled device, typically operated in a motor vehicle. As the vehicle is operated, the GPS-enabled device continuously monitors the location of the vehicle and compares it against the database of known locations of traffic control devices. These GPS devices are then enabled to sound an alert, or otherwise notify the vehicle operator, when the vehicle is in the presence of such a device. Typically, this type of GPS device establishes a virtual perimeter around the known traffic control devices, and in the event that the vehicle enters the virtual perimeter. In some examples of the prior art, the diameter of the perimeter around the known traffic control device may change given the vehicle's speed.

However, such devices are limited in that they are unable to provide a directional indication of the location of the traffic control device. Furthermore, because of this limitation, these devices are unable to provide any indication or suggestion as to whether the traffic control device is operating on the roadway on which the vehicle is traveling. For example, in many cities, limited access highways are often abutted by city streets or frontage roads. If the city street or frontage road is monitored by a traffic control device, prior GPS-enabled devices operated on the abutting highway may sound an alert, despite the fact that the vehicle is not in any danger of encountering the traffic control device, simply because the vehicle has entered the virtual perimeter established around the traffic control device. Similarly, in dense urban areas, parallel city streets may be so close to one another, and the virtual perimeters established around the traffic control devices so large, that vehicles operating as much as one block away from the traffic control device may trigger an alarm. Again, a vehicle traveling on one of these parallel streets is not likely to actually enter the intersection or section of roadway monitored by the traffic control device. However, because the vehicle has entered the virtual perimeter established around the traffic control device, an alert has been sounded. In both of these situations, without an indication as to the direction in which the point of interest is located, a driver/operator of a prior GPS-enabled device will be unaware as to the relevance of the alert.

In one or more embodiments of the present invention, the location-based alert device just described may be incorporated into a traditional radar detector, providing the operator with the benefits of both conventional detection of speed detection radar as well as improved indication of a fixed red light camera or other traffic control devices.

The present invention addresses these problems by providing a visual directional indicator indicating the general location of the point of interest, whether the point of interest is a traffic control device, or some other user-selected point. By comparing the indicated general direction of the point of interest to their own direction of travel, an operator of the present device is able to estimate whether or not the point of interest is likely in their direction of travel, and may act on, or ignore, the warning as appropriate.

### SUMMARY OF THE INVENTION

It is an object of the present invention to provide an apparatus that is enabled to provide a directional indication of the location of various known and user-generated points of interest.

It is a further object of the present invention to provide an in-vehicle apparatus enabled to provide a directional indication of the location of various known and user generated points of interest.

It is a further object of the present invention to provide an apparatus enabled to provide a visual directional indication of the location of various known and user-generated points of interest.

It is a further object of the present invention to provide an apparatus which utilizes a visual display consisting of a system of arrows to indicate the location of various known and user-generated points of interest.

It is a further object of the present invention to provide an apparatus enabled to provide a mutable audio alert to the presence of one or more points of interest.

It is a further object of the present invention to provide an apparatus which utilizes at least two visual displays, one of which may be superimposed over another to form a picture-in-picture.

It is a further object of the present invention to provide an apparatus which is enabled to provide audio and/or visual alerts to multiple points of interest, and which may prioritize such multiple alerts based on a default or user generated prioritization scheme.

It is a further object of the present invention to provide a location-based alert device that is enabled to provide a directional indication of the location of various known and user-generated points of interest.

It is a further object of the invention to provide a radar detector further enabled to provide a directional indication of the location of various known and user generated points of interest.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description. Furthermore, the figures shown are specific to only one particular embodiment of the communication device described.

### BRIEF DESCRIPTION OF THE DRAWINGS

The present invention will become more fully understood from the detailed description and the accompanying drawings, wherein:

FIG. 1 is a view of the front of one embodiment of the apparatus of the present invention.

FIG. 2 is a schematic depicting an example of operation of the present system.

FIG. 3 is a view of an alternate display of one embodiment of the apparatus of the present invention.

### DETAILED DESCRIPTION OF THE PREFERRED EMBODIMENTS

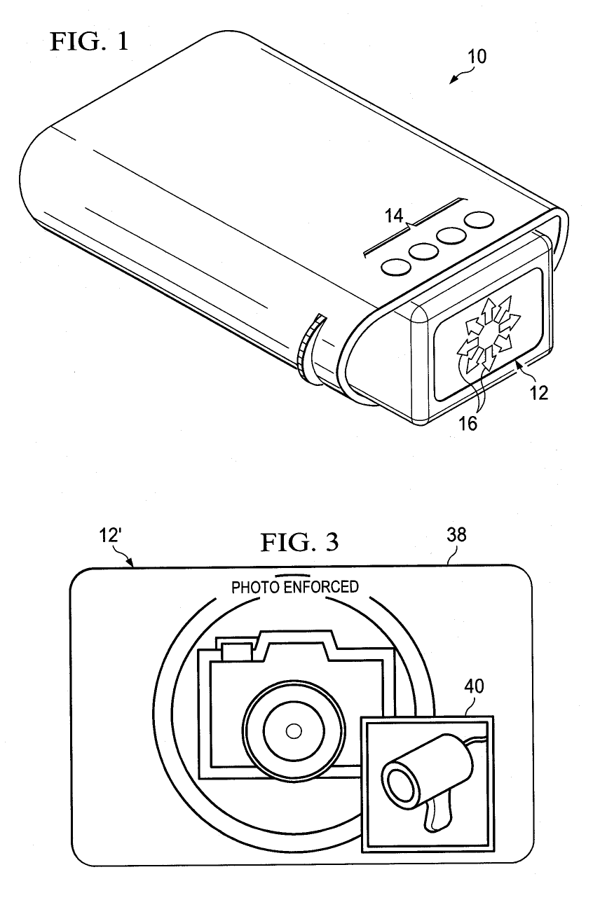

With reference to FIG. 1, a radar detector 10 is shown wherein the radar detector 10 is further enabled to act as a location-based alert device according to the principles of the present invention. Radar detector 10 is comprised of a display 12 and user interface 14. Display 12 is shown with directional indicators 16. In this embodiment, directional indicators 16 are depicted as eight arrows, each oriented from an adjacent arrow by 45 degrees. Of course, the directional indicators could be shaped in any way, and the number of directional arrows may be varied as well, all without deviating from the scope of the invention. In a preferred embodiment, display 12 may consist of a single animated arrow or other pointer, and screen 12 will have a level of resolution sufficient to display directional indicator 16 in at least 16 directions so as to provide a more precise indication of the direction in which the point of interest lies. Radar detector 10 also incorporates a receiver capable of receiving an incoming GPS signal, and a memory device containing a database of reference points, either fixed, or automatically or user updatable. The database may be updated using user interface 14 and/or by connecting to an external device, such as a computer, a cellular telephone, a server, another electromagnetic signal detector, or any other similar device and remain within the scope and spirit of the invention.

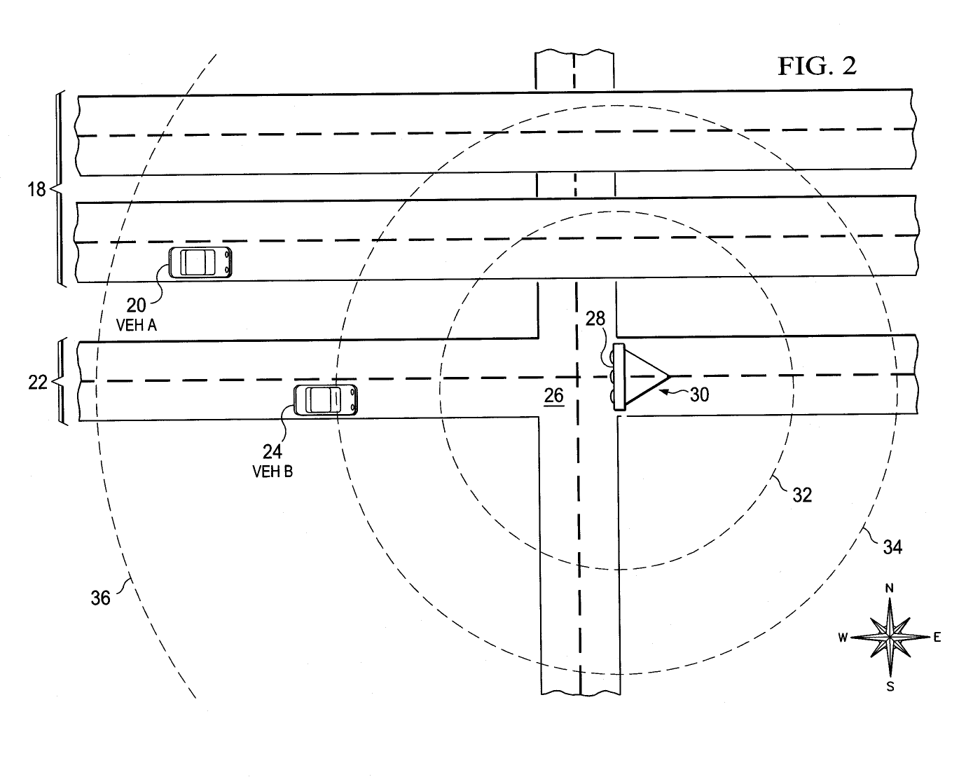

With reference to FIG. 2, an example of the present invention used in a traffic situation is depicted. Divided highway 18 is shown with Vehicle A 20 headed eastbound. Simultaneously, adjacent surface street 22 is depicted with Vehicle B also traveling eastbound, and approaching intersection 26 and traffic light 28. Point of interest 30, which in this case is a red-light camera, is shown as an arrow attached to traffic light 28 and indicates that traffic light 28 is monitored by a red-light camera and that the enforcement direction is eastbound. Vehicle A 20 and Vehicle B 24 are both equipped with the radar detector with location-based alert technology 10 of the present invention.

In the case of Vehicle B 24, radar detector 10 will display an indication that point of interest 30 lies ahead, and in some embodiments, will specify that point of interest 30 is a red-light camera. As Vehicle B 24 is traveling along surface street 22, in the direction of point of interest 30, display 12 and directional indicators 16 will continuously indicate that point of interest 30 is ahead, informing the driver that he or she is likely to encounter point of interest 30 and should take appropriate action.

Conversely, in the case of Vehicle A 20 traveling on divided highway 18, depending on the distance from point of interest 30 at which radar detector 10 begins to alert the driver to the presence of point of interest 30, the resolution of display 12, and the angle between point of interest 30 and radar detector 10, display 12 will indicate a direction from Vehicle A 20 to point of interest 30. While Vehicle A 20 is a significant distance from point of interest 30, and the angle between Vehicle A 20 and point of interest 30 is small, and given the resolution of display 12, the initial indication may be that point of interest 30 is relatively straight ahead. However, as Vehicle A 20 approaches point of interest 30, the angle between Vehicle A 20 and point of interest 30 will increase. Consequently, display 12 and directional indicators 16 will begin to indicate that point of interest 30 is not directly ahead of Vehicle A 20, but rather, in this case, to the right side. Of course, as the driver comes closer to point of interest 30, display 12 and directional indicators 16 will more strongly indicate to the driver that point of interest 30 is not in the driver's line of travel, but rather is, in this case, to the driver's right. With this information, and based on situational information such as the vehicle speed and the type of road being driven on, the driver can make a more informed decision as to whether the signaled point of interest is relevant.

Furthermore, as previously noted, in some embodiments, radar detector 10 will further indicate that point of interest 30 is a red-light camera. In the situation depicted in FIG. 2, where Vehicle A 20 is traveling on a limited access highway, it will be obvious to the driver that the red-light camera alert is irrelevant and may be ignored. Of course, use of the present device is in no way intended to substitute for safe driving practices and all rules of the road should be followed at all times.

In further embodiments of the present invention, radar detector 10 may provide different modalities based on the speed of the vehicle in which it is traveling, and/or the distance from the detector to a point of interest. For example, radar detector 10 may store not only points of interest, but also one or more virtual perimeters around one or more points of interest. Thereafter, as a radar detector 10 passes within these virtual perimeters, various modalities may be triggered within radar detector 10. As shown in FIG. 2, inner virtual perimeter 32 may be placed relatively close to point of interest 30, middle virtual perimeter 34 a greater distance from point of interest 30 and outer virtual perimeter 36 a significant distance from point of interest 30. In one embodiment, inner virtual perimeter 32 may describe a circle around point of interest 30 with a radius of 400 feet, middle virtual perimeter 34 a circle with a radius of 1,250 feet, and outer virtual perimeter 36 a circle with a radius of 2,500 feet. Depending on the virtual perimeter penetrated, radar detector 10 may alter the color of its displays, may sound an audible alert in addition to the visual display, may mute an audible alert, or may take some other action. Furthermore, radar detector 10 will generally take no action with regard to a particular point of interest until at least the outermost virtual perimeter around that point of interest has been penetrated. In addition, variations in the speed of the vehicle in which radar detector 10 is placed may prompt radar detector 10 to make similar changes in its mode of operation. Finally, combinations of various vehicle speeds, virtual perimeters penetrated, and variations in the angle between radar detector 10 and point of interest 30 may be used to alter the functions of radar detector 10.

In another embodiment, radar detector 10 may be equipped with an alternate display capable of provide multiple simultaneous alerts. In FIG. 3, alternate display 12′ is depicted with primary display 38 providing an alert to a point of interest which, in this case, is a red-light camera. Simultaneously, secondary display 40 is alerting the driver that vehicle speed in the area is being monitored with a laser. Of course, the particular point of interest and secondary alert depicted could be altered. Furthermore, directional indicators 16 could also be incorporated, either superimposed over primary display 38, or in an alternating sequence between the alert and the directional indicators.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electromagnetic signal detector for detecting a signal and generating an alert comprising:
a GPS receiver;
a memory device containing at least one database of reference points;
a user interface; and
a display, wherein said display is enabled to provide an indication of the direction to a point of interest from the electromagnetic signal detector.

2. The electromagnetic signal detector of claim 1 wherein the electromagnetic signal detector is a radar detector.

3. The electromagnetic signal detector of claim 1 wherein said display comprises a number of displayed indicators capable of indicating a direction.

4. The electromagnetic signal detector of claim 1 wherein said display is capable of providing multiple simultaneous alerts.

5. The electromagnetic signal detector of claim 1 wherein said at least one database of reference points further comprises one or more data point(s) describing a virtual perimeter around at least one of said reference points.

6. The electromagnetic signal detector of claim 1 wherein said at least one database of reference points is updatable.

7. The electromagnetic signal detector of claim 6 wherein said at least one database of reference points is updatable by using said user interface.

8. The electromagnetic signal detector of claim 6 wherein said at least one database of reference points is updatable through communication with an external device.
